(19) United States
(12) Patent Application Publication
(10) Pub. No.: US 2015/0300403 A1
(43) Pub. Date: Oct. 22, 2015

(54) BEARING ASSEMBLIES INCLUDING SUPERHARD BEARING ELEMENTS CONFIGURED TO PROMOTE LUBRICATION AND/OR COOLING THEREOF, BEARING APPARATUS INCLUDING THE SAME, AND RELATED METHODS

(71) Applicant: US Synthetic Corporation, Orem, UT (US)

(72) Inventors: Jair J. Gonzalez, Provo, UT (US); Xiaobin Lu, Orem, UT (US)

(73) Assignee: US Synthetic Corporation, Orem, UT (US)

(21) Appl. No.: 14/255,507

(22) Filed: Apr. 17, 2014

(51) Int. Cl. F16C 17/04; F16C 33/04

(52) U.S. Cl. CPC F16C 17/04; F16C 33/043

(57) ABSTRACT

Bearing assemblies, apparatuses, and motor assemblies using the same are disclosed. In an embodiment, a bearing assembly may include a plurality of superhard bearing elements distributed circumferentially about an axis. Each of the superhard bearing elements may include a bearing surface and a side. At least one of the plurality of superhard bearing elements may include a hollow at least partially defined by a side of the superhard bearing element that is configured to force fluid toward the bearing surface during operation. The bearing assembly may also include a support ring that carries the superhard bearing elements.

### BACKGROUND

Subterranean drilling systems that employ downhole drilling motors are commonly used for drilling boreholes in the earth for oil and gas exploration and production. A subterranean drilling system typically includes a downhole drilling motor that is operably connected to an output shaft. A pair of thrust-bearing apparatuses also can be operably coupled to the downhole drilling motor. A rotary drill bit configured to engage a subterranean formation and drill a borehole can be connected to the output shaft. As the borehole is drilled with the rotary drill bit, pipe sections may be connected to the subterranean drilling system to form a drill string capable of progressively drilling the borehole to a greater size or depth within the earth.

Each thrust-bearing apparatus includes a stator that does not rotate relative to the motor housing and a rotor that is attached to the output shaft and rotates with the output shaft. The stator and rotor each includes a plurality of bearing elements that may be fabricated from polycrystalline diamond compacts (“PDCs”) that provide diamond bearing surfaces that bear against each other during use.

In operation, high-pressure drilling fluid may be circulated through the drill string and power section of the downhole drilling motor, usually prior to the rotary drill bit engaging the bottom of the borehole, to generate torque and rotate the output shaft and the rotary drill bit attached to the output shaft. When the rotary drill bit engages the bottom of the borehole, a thrust load is generated, which is commonly referred to as “on-bottom thrust” that tends to compress and is carried, at least in part, by one of the thrust-bearing apparatuses. Fluid flow through the power section may cause what is commonly referred to as “off-bottom thrust,” which is carried, at least in part, by the other thrust-bearing apparatus. The drilling fluid used to generate the torque for rotating the rotary drill bit exits openings formed in the rotary drill bit and returns to the surface, carrying cuttings of the subterranean formation through an annular space between the drilled borehole and the subterranean drilling system. Typically, a portion of the drilling fluid is diverted by the downhole drilling motor to cool and lubricate the bearing elements of the thrust-bearing apparatuses however, cooling and lubricating the bearing elements can be problematic, in part, because of inadequate surface area on each bearing element exposed to the drilling fluid and/or circulating air.

The on-bottom and off-bottom thrust carried by the thrust-bearing apparatuses can be extremely large and generate significant amounts of energy. The operational lifetime of the thrust-bearing apparatuses often can determine the useful life of the subterranean drilling system.

### SUMMARY

Various embodiments of the invention relate to bearing assemblies, bearing apparatuses and motor assemblies that include superhard bearing elements having features configured to promote lubrication and/or cooling of the superhard bearing elements during use.

In an embodiment, a bearing assembly may include a plurality of superhard bearing elements (e.g., non-cylindrical superhard bearing elements) distributed circumferentially about an axis. At least some of the plurality of superhard bearing elements include a bearing surface including a superhard material, and a leading side extending from the bearing surface. A side of at least some of the superhard bearing elements (e.g., the leading side) may at least partially define a hollow (e.g., concave hollow, recess, or pocket) sized and configured to force fluid toward the bearing surface during use. The bearing assembly may also include a support ring that carries the plurality of superhard bearing elements to which the superhard bearing elements are affixed.

In an embodiment, a bearing apparatus may include two bearing assemblies. At least one of the two bearing assemblies may be configured as any of the disclosed bearing assembly embodiments.

In an embodiment, a method for manufacturing a bearing assembly is disclosed. The method includes manufacturing a plurality of superhard bearing elements. At least some of the plurality of superhard bearing elements include a bearing surface including a superhard material and a leading side extending from the bearing surface. A side of at least some of the superhard bearing elements (e.g., the leading side) may at least partially define a hollow sized and configured to force fluid toward the bearing surface during use. The method further includes securing the plurality of superhard bearing elements to the support ring. In an embodiment, the hollow may be formed before securing the superhard bearing element to the support ring. In an embodiment, the hollow may be formed after securing the superhard bearing element to the support ring.

Other embodiments include downhole motors for use in drilling systems and subterranean drilling systems that may utilize any of the disclosed bearing apparatuses.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1A is an isometric view of a thrust-bearing assembly according to an embodiment.

FIG. 1B is an isometric view of three side-by-side superhard bearing elements removed from the thrust-bearing assembly shown in FIG. 1A.

FIG. 1C is a front elevation view of one of the superhard bearing elements shown in FIG. 1B.

FIG. 1D is a top plan view of the thrust-bearing assembly shown in FIG. 1A.

FIG. 1E is an isometric cutaway view taken along line 1E-1E of the thrust-bearing assembly shown in FIG. 1D.

FIG. 1F is a top plain view of a thrust bearing assembly according to another embodiment.

FIG. 2A is an isometric view of a superhard bearing element according to an embodiment.

FIG. 2B is an isometric view of a superhard bearing element according to an embodiment.

FIG. 2C is an isometric view of a superhard bearing element according to an embodiment.

FIG. 2D is an isometric view of a superhard bearing element according to an embodiment.

FIG. 3A is an isometric view of a superhard bearing element according to an embodiment.

FIG. 3B is a front elevation view of the superhard bearing element shown in FIG. 3A.

FIG. 3C is an isometric view of a superhard bearing element according to an embodiment.

FIG. 3D is a front elevation view of the superhard bearing element shown in FIG. 3C.

FIG. 3E is an isometric view of a superhard bearing element according to an embodiment.

FIG. 3F is a front elevation view of the superhard bearing element shown in FIG. 3E.

FIG. 4A is an isometric view of a superhard bearing element according to an embodiment.

FIG. 4B is a front elevation view of the superhard bearing element shown in FIG. 4A.

FIG. 4C is an isometric view of a superhard bearing element according to an embodiment.

FIG. 4D is a front elevation view of the superhard bearing element shown in FIG. 4C.

FIG. 4E is an isometric view of a superhard bearing element according to an embodiment.

FIG. 4F is a front elevation view of the superhard bearing element shown in FIG. 4E.

FIG. 5A is an isometric view of a thrust-bearing apparatus that may employ any of the disclosed thrust-bearing assemblies according to an embodiment, with the housing shown in cross-section.

FIG. 5B is a cross-sectional view of the thrust-bearing apparatus shown in FIG. 5A taken along line 5B-5B.

FIG. 5C is an exploded isometric view of the thrust-bearing assemblies in the thrust-bearing apparatus depicted in FIGS. 5A and 5B.

FIG. 6A is an isometric view of a radial bearing assembly according to an embodiment.

FIG. 6B is an isometric cutaway view of the radial bearing assembly shown in FIG. 6A taken along line 6B-6B.

FIG. 7 is an isometric cutaway view of a radial bearing apparatus that may utilize any of the disclosed radial bearing assemblies according to various embodiments.

FIG. 8 is an isometric cutaway view of two radial bearing apparatuses that may utilize any of the disclosed radial bearing assemblies according to various embodiments.

FIG. 9 is a schematic isometric cutaway view of a subterranean drilling system that may utilize any of the disclosed bearing assemblies according to various embodiments.

### DETAILED DESCRIPTION

Embodiments of the invention relate to bearing assemblies, bearing apparatuses and motor assemblies that include superhard bearing elements having features configured to provide lubrication and/or cooling of the superhard bearing elements during use. When the superhard bearing elements are closely-spaced from each other or abutting each other to form a quasi/substantially continuous bearing surface, the superhard bearing elements may not be able to effectively cool during use and providing one or more hollows (e.g., one or more cut-outs, recesses, or pockets) adjacent to at least some of the superhard bearing elements may promote lubrication and/or cooling thereof during use.

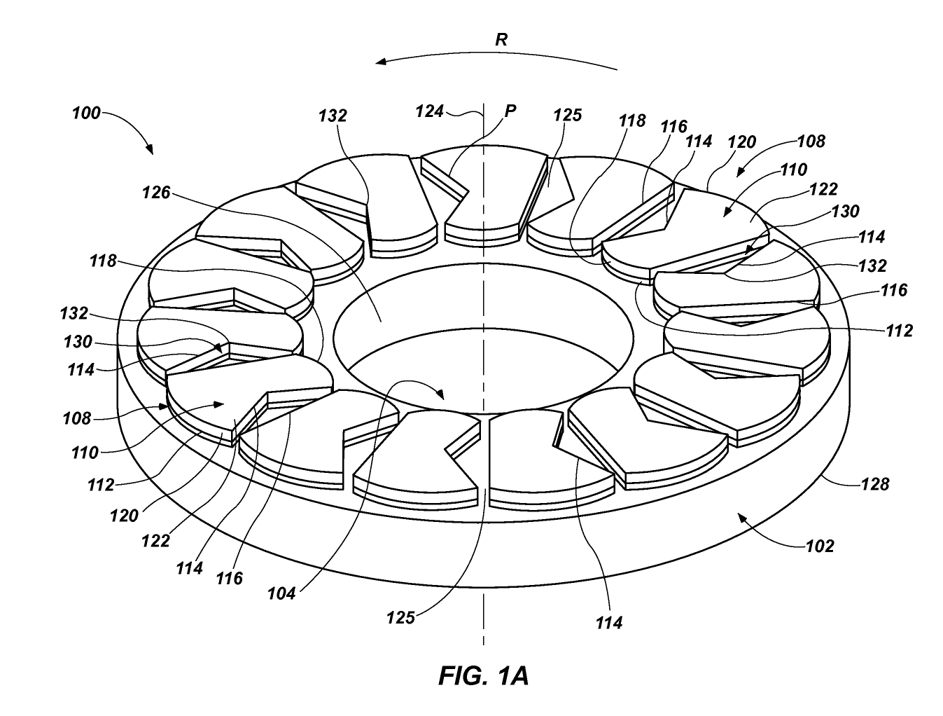

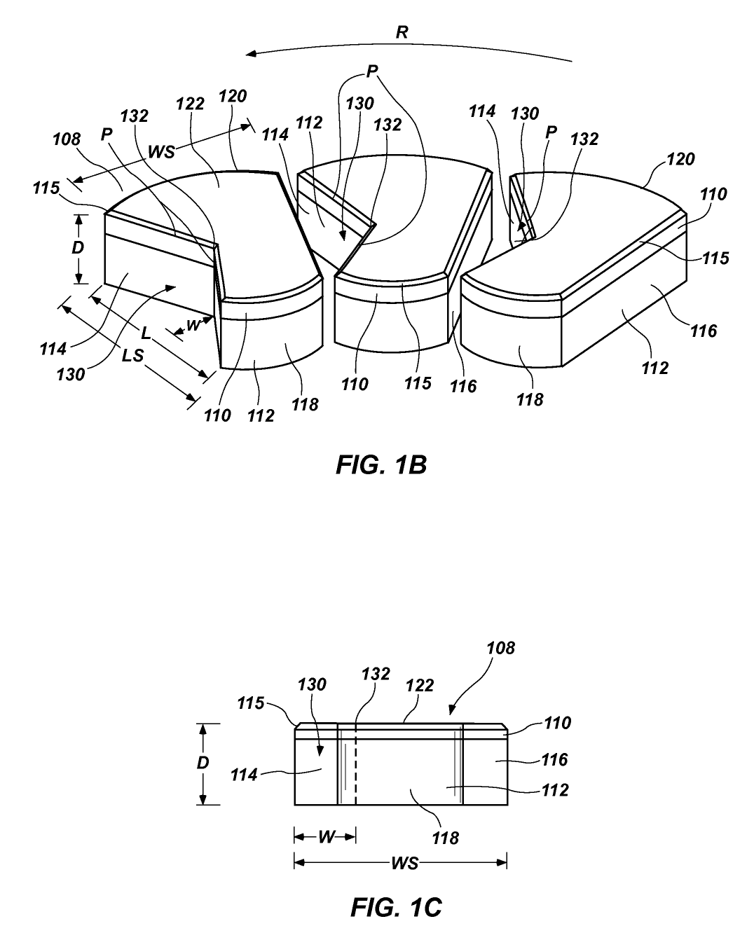

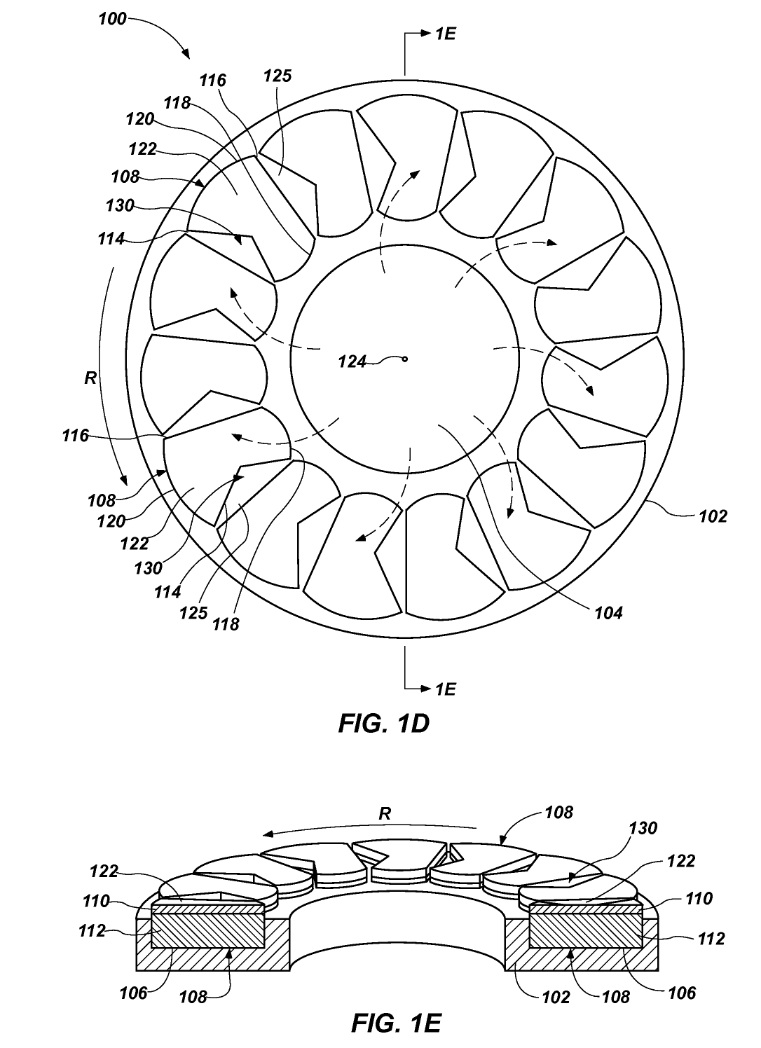

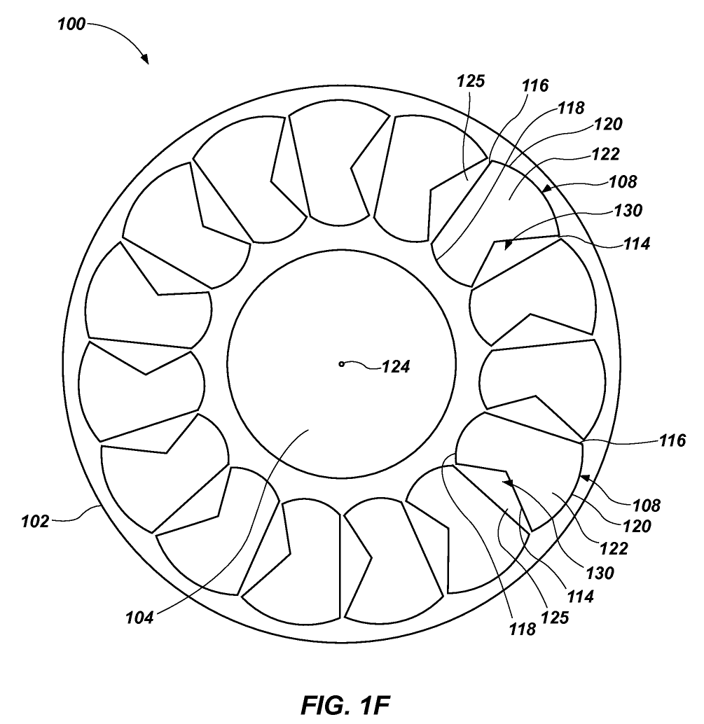

As shown in FIGS. 1A and 1B, a thrust-bearing assembly 100 may form a stator or a rotor of a thrust-bearing apparatus used in a subterranean drilling system. The thrust-bearing assembly 100 may include a support ring 102 defining an opening 104 through which a shaft (not shown) of, for example, a downhole drilling motor may extend. The support ring 102 may be made from a variety of different materials. For example, the support ring 102 may comprise a metal, steel, carbon steel, stainless steel, tungsten carbide, copper, or any other suitable conductive or non-conductive material. The support ring 102 may include a plurality of recesses 106 (shown in FIG. 1E) formed therein.

The thrust-bearing assembly 100 may further include a plurality of superhard bearing elements 108. As shown in FIG. 1B, the superhard bearing elements 108 may include a superhard table 110 bonded to a substrate 112 including a leading side 114 based on the relative rotation of the superhard bearing element, a trailing side 116 based on the relative rotation of the superhard bearing element, a first end 118, a second end 120, and a bearing surface 122 of the superhard table 110. The leading side of the bearing elements is the side of the bearing element on the support ring that initially contacts a bearing element of an opposite support ring when one or both of the support rings is rotated. The leading side 114 of relative rotation is defined, by the direction of rotation “R” of the rotor. The superhard bearing elements 108 are illustrated in FIG. 1A being distributed circumferentially about a thrust axis 124 along which a thrust force may be generally directed during use. As shown in FIGS. 1A and 1D, gaps 125 may be located between adjacent superhard bearing elements 108. In other embodiments, the gaps 125 may have widths that are relatively larger or smaller. In other embodiments, the gaps 125 may be at least partially defined by a hollow 130 defined by the leading side 114 the superhard bearing element 108. Increased cooling, lubrication and development of hydrodynamic lift require that the gap 125 between the individual superhard bearing elements 108 be sufficiently large to expose the leading side of the bearing elements to sufficient amount of drilling mud or coolant upon rotation of the bearing assembly. Accordingly, the hollow 130 may provide a larger gap between a superhard bearing element 108 and another superhard bearing element 108 that is rotationally in front of the first superhard bearing element 108. Therefore, it may be desirable that the trailing side 116 is not complementary in shape to the leading side 114 so that there is a large enough and/or non-uniform gap to expose the hollow 130 to a sufficient amount of fluid. In an embodiment, at least one of, some of, or all of the gaps 125 may exhibit a maximum width (i.e., width at the apex of a hollow) of more than about 0.001 inches, such as about 0.002 inches to 0.500 inches, about 0.0040 inches to 0.200 inches, about 0.010 inches to 0.100 inches, about 0.050 inches to about 0.080 inches, about 0.500 inches, about 0.100 inches, about 0.05 inches, more than about 0.100 inches, or more than about 0.500 inches.

Each of the superhard bearing elements 108 may be partially disposed in a corresponding one of the recesses 106 (shown in FIG. 1E) of the support ring 102 and secured partially therein via brazing, press-fitting, threadly attaching, fastening with a fastener, combinations of the foregoing, or another suitable technique. As used herein, a “superhard bearing element” is a bearing element including a bearing surface that is made from a material exhibiting a hardness that is at least as hard as tungsten carbide. In an embodiment, the recesses 106 are formed with a shape complementary to the superhard bearing elements 108. In another embodiment, the recesses 106 are formed in a shape that is not complementary to the superhard bearing elements 108 yet still accommodates the superhard bearing elements 108 therein. As a non-limiting example, the recess 106 may be formed in a substantially rectangular or cylindrical shape yet still accommodate a smaller wedge-shaped superhard bearing element 108.

In any of the embodiments disclosed herein, the superhard bearing elements 108 may be made from one or more superhard materials, such as polycrystalline diamond, polycrystalline cubic boron nitride, silicon carbide, tungsten carbide, or any combination of the foregoing superhard materials. For example, the superhard table 110 may be formed from polycrystalline diamond and the substrate 112 may be formed from cobalt-cemented tungsten carbide. Furthermore, in any of the embodiments disclosed herein, the polycrystalline diamond table may be leached to at least partially or substantially completely remove a metal-solvent catalyst (e.g., cobalt, iron, nickel, or alloys thereof) that was used to initially sinter precursor diamond particles that form the polycrystalline diamond table. In another embodiment, an infiltrant used to re-infiltrate a preformed leached polycrystalline diamond table may be leached or otherwise removed to a selected depth from a bearing surface. Moreover, in any of the embodiments disclosed herein, the polycrystalline diamond table may be unleached and include a metal-solvent catalyst (e.g., cobalt, iron, nickel, or alloys thereof) that was used to initially sinter the precursor diamond particles that form the polycrystalline diamond table and/or an infiltrant used to re-infiltrate a preformed leached polycrystalline diamond table. Examples of methods for fabricating the superhard bearing elements and superhard materials from which the superhard bearing elements can be made are disclosed in U.S. Pat. Nos. 7,866,418, 7,998,573, 8,034,136, 8,080,071, and 8,080,074; the contents of each of the foregoing patents are incorporated herein, in their entirety, by this reference.

The diamond particles that may be used to fabricate the superhard table 110 in a high-pressure/high-temperature process (“HPHT)” may exhibit a larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the diamond particles may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.5 μm, less than 0.5 μm, 0.1 μm, less than 0.1 μm). In an embodiment, the diamond particles may include a portion exhibiting a relatively larger size between about 10 μm and about 40 μm and another portion exhibiting a relatively smaller size between about 1 μm and 4 μm. In some embodiments, the diamond particles may comprise three or more different sizes (e.g., one relatively larger size and two or more relatively smaller sizes), without limitation. The resulting polycrystalline diamond formed from HPHT sintering the aforementioned diamond particles may also exhibit the same or similar diamond grain size distributions and/or sizes as the aforementioned diamond particle distributions and particle sizes.

Additionally, in any of the embodiments disclosed herein, the superhard bearing elements 108 may be free-standing (e.g., substrateless) and formed from the polycrystalline diamond table/body that is at least partially or fully leached to remove the metal-solvent catalyst initially used to sinter the polycrystalline diamond table/body.

Referring now to FIG. 1B, the leading side 114 and the trailing side 116 of each of the superhard bearing elements 108 may extend between the first end 118 and the second end 120 and vice versa. At least one of the superhard bearing elements 108 may have a length LS defined between the first end 118 and the second end 120. In an embodiment, the leading side 114 and the trailing side 116 may be non-parallel to each other such that the superhard bearing elements 108 have a wedge-like shape. In other embodiments, the leading side 114 and the trailing side 116 may be configured such that the superhard bearing elements 108 have a partial generally rectangular shape, a partial generally oval shape, another non-cylindrical shape, a partial generally cylindrical shape, or another suitable configuration. In the embodiment depicted in FIG. 1B, both the first end 118 and the second end 120 may have a convex curvature. In an embodiment, all, some, or none of the leading side 114, the trailing side 116, the first end 118, second end 120 and the bearing surface 122 may include at least one of substantially planar surface, a rounded surface, a chamfered surface, a textured surface, or combinations thereof.

As shown in FIG. 1B, the second end 120 may have a convex curvature to at least partially complement an outer peripheral surface 128 of the support ring 102. In other embodiments, the first end 118 and the second end 120 may have symmetrical edge configurations, asymmetrical edge configurations, curved edge configurations, irregular edge configurations, or other edge configurations. For example, the first end 118 and the second end 120 may take the form of any portion of a circle, oval, square, rectangle, rhombus, triangle, or virtually any other simple, complex, regular, irregular, symmetrical, or non-symmetrical geometric shape. Moreover, the second end 120 may have an area greater than an area of the first end 118, although this feature is not necessary. In other embodiments, the first end 118 and the second end 120 may be substantially the same width (e.g., a substantially rectangular shaped superhard bearing element 108).

The bearing surface 122 of the superhard table 110 may extend between the first end 118, the second end 120, the leading side 114, the trailing side 116, and may be substantially planar and generally lie in common plane (shown in FIG. 1E) with the bearing surfaces 122 of the other superhard bearing elements 108. The superhard bearing elements 108 may be pre-machined to tolerances and mounted in the support ring 102 and/or mounted to the support ring 102. The bearing surfaces 122 may be planarized (e.g., by lapping and/or grinding) so that the bearing surfaces 122 are substantially coplanar. As shown in FIG. 1A, the superhard bearing elements 108 may be arranged circumferentially adjacent to one another to form a quasi-continuous bearing surface. Optionally, as depicted in FIGS. 1B and 1C, one or more of the superhard bearing elements 108 may exhibit a peripherally extending edge chamfer 115 extending around the entire bearing surface or a portion of the bearing surface 122 (e.g., a chamfer formed only along the leading side 114 adjacent to the bearing surface 122). However, in other embodiments, the edge chamfer may be omitted. Optionally, one or more of the superhard bearing elements 108 may exhibit a relieved (i.e. chamfered or fileted) edge on at least one of the intersections of the leading side 114, the trailing side 116, the first end 118, the second end 120 and the bearing surface 122. However, in other embodiments, a relieved edge may be omitted

At least some the superhard bearing elements 108 may each define at least one hollow 130 (e.g., a cut-out) sized and configured to pump lubricating fluid toward the bearing surface 122 and/or influence the cooling and/or hydrodynamic lift of the superhard bearing elements 108. When the superhard bearing elements 108 are closely-spaced from or abutting each other to form a quasi/substantially continuous bearing surface of the individual bearing surfaces 122, the superhard bearing elements 108 may not be able to effectively cool, lubricate, or form hydrodynamic film thereon during use. Therefore, in an embodiment, the hollow 130 may be formed in leading side 114 of the superhard bearing element 108. In an embodiment, the hollow 130 may form a gap that increases to a maximum value and then decreases as measured between adjacent superhard bearing elements in a radially inward direction from the second end 120 toward the first end 118. The hollow 130 may be formed by electro-discharge machining (“EDM”), laser-cutting, grinding, combinations thereof, or otherwise machining the hollow 130 in the bearing surface 122 before or after securing the superhard bearing elements 108 to the support ring 102. For example, suitable laser-cutting techniques are disclosed in U.S. application Ser. No. 13/166,007 filed on Jun. 22, 2011, the disclosure of which is incorporated herein, in its entirety by this reference.

In other embodiments, the hollow 130 may be formed by using a sacrificial material to define the hollow 130 during formation (i.e., sintering) of the superhard table 110 and/or the substrate 112. The sacrificial material may include metals (e.g., tungsten), alloys (e.g., tungsten alloys), ceramics (e.g., tungsten carbide or silicon carbide), pyrophyllite, combinations thereof, or the like. Once the hollow 130 is defined, the sacrificial material may be removed via leaching, blasting, grinding, thermal decomposition, combinations thereof, or other removal techniques.

The hollow 130 may follow a pathPin the bearing surface 122 with a length L that extends generally between the first end 118 and the second end 120, thereby at least partially defining the leading side 114. In other words, the length L of the hollow 130 may extend along only a portion of the leading side 114. For example, the length L of the hollow 130 may extend between the first end 118 and an intermediate point between the first end 118 and the second end 120, the length L of the hollow 130 may extend between two intermediate points between the first end 118 and the second end 120, or the length L of the hollow 130 may extend between the first end 118 and the second end 120. Moreover, while the hollow 130 is illustrated in FIGS. 1A-1F following a generally V-shaped (when viewed from a top view: perpendicular to bearing surface 122) path P, the hollow 130 may follow a generally arcuate path P, a semi-cylindrical path P, a generally U-shaped path P, a generally multi-angular path P, the like, or combinations thereof.

In an embodiment, the length L of the hollow 130 may be about 0.2 inches to about 2 inches, such as about 0.3 inches to about 1 inch, about 0.2 inches to about 0.7 inches, about 0.3 inches to about 0.6 inches, about 0.4 inches to about 0.5 inches, about 0.2 inches, about 0.3, inches, about 0.4 inches, about 0.5 inches, about 0.6 inches, or about 0.7 inches. However, in other embodiments, the length L of the hollow 130 may be longer or shorter than the foregoing ranges, depending on the overall length LS of the superhard bearing element 108 and the desired extent of the pumping effect of the hollow 130. As illustrated in FIG. 1A, each of the hollows 130 may have at least substantially the same length L. However, in other embodiments, some or all of the hollows 130 may have substantially different paths P and/or lengths L, respectively. For example, in an embodiment, a first group of superhard bearing elements 108 may define a first group of hollows 130 having lengths L of about one (1) inch and a generally V-shaped path while a second group of superhard bearing elements 108 may define a second group of hollows 130 having lengths L of about 0.5 inch and a generally U-shaped path.

While all the superhard bearing elements 108 are shown including substantially identical hollows 130, in other embodiments, only a portion of the superhard bearing elements 108 may have substantially identical hollows 130 and/or the superhard bearing elements 108 may have hollows 130 of varying sizes and configurations. In another embodiment, the first group of superhard bearing elements 108 may define a group of hollows 130 which may exhibit a generally V-shaped path, and the second group of superhard bearing elements opposing the first group of superhard bearing elements may not include a hollow.

FIG. 1C is a front elevation view of one of the superhard bearing elements 108 shown in FIG. 1B. The superhard bearing elements 108 may have a generally uniform width WS which is substantially less than the length LS of the superhard bearing elements 108, although it will be appreciated that these dimensions are illustrative only. For, example, the superhard bearing elements 108 may also have a width WS which is substantially larger than the length LS of the superhard bearing elements. In another embodiment, the width WS may be substantially the same as the length LS of the superhard bearing element 108. The superhard bearing elements 108 may define the hollow 130 having a maximum width W at apex 132.

In an embodiment, the relationship between the length L of the hollows 130 and the length LS of the superhard bearing elements 108 may be configured to increase lubrication and/or cooling of the superhard bearing elements 108. For example, increasing the length L of one or more of the hollows 130 relative to the length LS of one or more of the superhard bearing elements 108 may increase the percentage of surface area of the bearing surfaces 122 and/or the superhard bearing elements 108 in contact with the lubricating fluid to cool the superhard bearing elements 108. For example, increasing the length L of one or more of the hollows 130 relative to the length LS of one or more of the superhard bearing elements 108 may increase the amount of lubricating fluid pumped or forced toward the bearing surface 122 to lubricate, cool or provide hydrodynamic lift to the superhard bearing elements 108. The length L of at least one of the hollows 130 may be at least: about twenty (20) percent; about forty (40) percent; about sixty (60) percent; about eighty percent (80) percent; about ninety (90) percent; or about one hundred (100) percent of the length LS of the superhard bearing elements 108. In other embodiments, the length L of one or more of the hollows 130 may be about forty (40) percent to about one hundred (100) percent; about sixty (60) percent to about ninety (90) percent; at least about fifty (50) percent, or at least about seventy five (75) percent of the length LS of at least one of the superhard bearing elements 108. In other embodiments, the length L of one or more of the hollows 130 and the length LS of one or more of the superhard bearing elements 108 may be larger or smaller relative to each other.

Similar to the relationship between the length L of the hollows 130 and the length LS of the superhard bearing elements 108, the relationship between the width W of the hollows 130 and the width WS of one or more of the superhard bearing elements 108 may be configured to increase lubrication and/or cooling of the superhard bearing elements 108. For example, increasing or decreasing the width W of one or more of the hollows 130 relative to the width WS of one or more of the superhard bearing elements 108 may increase the amount of lubricating fluid pumped or forced toward the bearing surface 122 to lubricate, cool, or provide hydrodynamic lift the superhard bearing elements 108. For example, the width W of at least one of the hollows 130 may be at least: about five (5) percent, about ten (10) percent; about twenty (20) percent; about thirty (30) percent; about forty (40) percent; about fifty (50) percent; about sixty (60) percent; about seventy (70) percent; or about eighty (80) percent of the width WS of at least one of the superhard bearing elements 108. In other embodiments, the width W of at least one of the hollows 130 may be between about five (5) percent and about sixty (60) percent; or between about twenty (20) percent and about fifty (50) percent, between about ten (10) percent and about thirty (30) percent, or about thirty (30) percent of the width WS of at least one of the superhard bearing elements 108. In other embodiments, the width W of one or more of the hollows 130 and the width WS of one or more of the superhard bearing elements 108 may be larger or smaller relative to each other.

Similar to the relationship between the length L of the hollows 130 and the length LS of the superhard bearing elements 108, the relationship between the width W of the hollows 130 and the length LS of one or more of the superhard bearing elements 108 may be configured to increase lubrication, cooling and/or hydrodynamic lift or behavior of the superhard bearing elements 108 during operation. For example, increasing or decreasing the width W of one or more of the hollows 130 relative to the length LS of one or more of the superhard bearing elements 108 may increase the amount of lubricating fluid pumped or forced toward the bearing surface 122. For example, it may be desirable to provide the hollow 130 having a greater width W for the bearing element 108 having a longer length LS, or it may be desirable to provide the hollow 130 having a smaller width W for the bearing element 108 with a shorter length LS.

Similar to the relationship between the length L of the hollows 130 and the length LS of the superhard bearing elements 108, the relationship between the length L of the hollows 130 and the width WS of one or more of the superhard bearing elements 108 may be configured to increase lubrication, cooling and/or hydrodynamic of the superhard bearing elements 108. For example, increasing or decreasing the length L of one or more of the hollows 130 relative to the width WS of one or more of the superhard bearing elements 108 may increase the amount of lubricating fluid pumped or forced toward the bearing surface 122. For example, it may be desirable to provide the hollow 130 having a greater length L for the bearing element 108 having a wider width WS, or it may be desirable to provide the hollow 130 having a smaller length L for the bearing element 108 with a smaller width WS.

In an embodiment, the relationship between the length L of the hollows 130 and the width W of the hollows of one or more superhard bearing elements 108 may be configured to increase lubrication and/or cooling of the superhard bearing elements 108. For example, increasing the length L of one or more of the hollows 130 relative to the width W of the hollows 130 of one or more of the superhard bearing elements 108 may increase the percentage of surface area of the bearing surfaces 122 and/or the superhard bearing elements 108 (i.e. more area of the leading side) in contact with the lubricating fluid to cool the superhard bearing elements 108. Additionally, increasing the length L of one or more of the hollows 130 relative to the width W of the hollows 130 of one or more of the superhard bearing elements 108 may increase the amount of lubricating fluid pumped or forced toward the superhard bearing surface 122 to lubricate, cool, or provide hydrodynamic lift to the superhard bearing elements 108. The width W of the hollows 130 may be at least: about ten (10) percent; about twenty (20) percent; about thirty (30) percent; about fifty (50) percent; about seventy five percent (75) percent; or about one hundred (100) percent of the length L of hollows 130 of the one or more the superhard bearing elements 108. In other embodiments, the length L of one or more of the hollows 130 may be about forty (40) percent to about one hundred (100) percent; about sixty (60) percent to about ninety (90) percent; or at least about seventy five (75) percent of the length LS of at least one of the superhard bearing elements 108. In other embodiments, the length L of one or more of the hollows 130 and the length LS of one or more of the superhard bearing elements 108 may be larger or smaller relative to each other. In an embodiment, a hollow may be formed by the leading side 114 of the superhard bearing element 108 at the midpoint between the first end 118 and the second end 120 along the leading side 114. In an embodiment, a hollow 130 may be formed by the leading side 114 of the superhard bearing element 108 off center from (i.e., above or below) the midpoint between first end 118 and the second end 120 along the leading side 114.

By reducing friction and/or increasing heat dissipation (i.e., cooling), the hollows 130 may reduce wear of the superhard bearing elements 108 and help prolong the useful life of the superhard bearing elements 108.

Referring to FIGS. 1B and 1C, each of the hollows 130 may be further defined by a bottom portion at a depth D of the overall depth DS of the superhard bearing element 108. Alternatively, the depth D may be defined relative to the support ring 102. The hollow 130 may be defined by substantially planar surfaces at least partially defining the leading side 114 and the bearing surface 122. In other embodiments, the bearing elements 108 may include beveled edges, rounded edges, chamfered edges, or the like.

As illustrated in FIG. 1C, the hollow 130 may have a generally rectangular cross-section. In other embodiments, the hollow 130 may have a generally ramped cross-section, a generally rounded cross-section, combinations thereof, or the like. The cross-section of the hollow 130 may influence the pumping or forcing of the lubricating fluid and/or the cooling of the superhard bearing elements 108. For example, in an embodiment, at least one of the hollows 130 may have a portion including a ramped cross-section configured to provide cooling of the superhard bearing element 108 and lubrication of the bearing surface 122 by directing the lubricating fluid through that portion of the hollow 130. In other embodiments, the hollows 130 may include a first deeper cross-sectional shape followed by a second shallower cross-sectional shape to pump or direct the lubricating fluid onto the bearing surfaces 122.

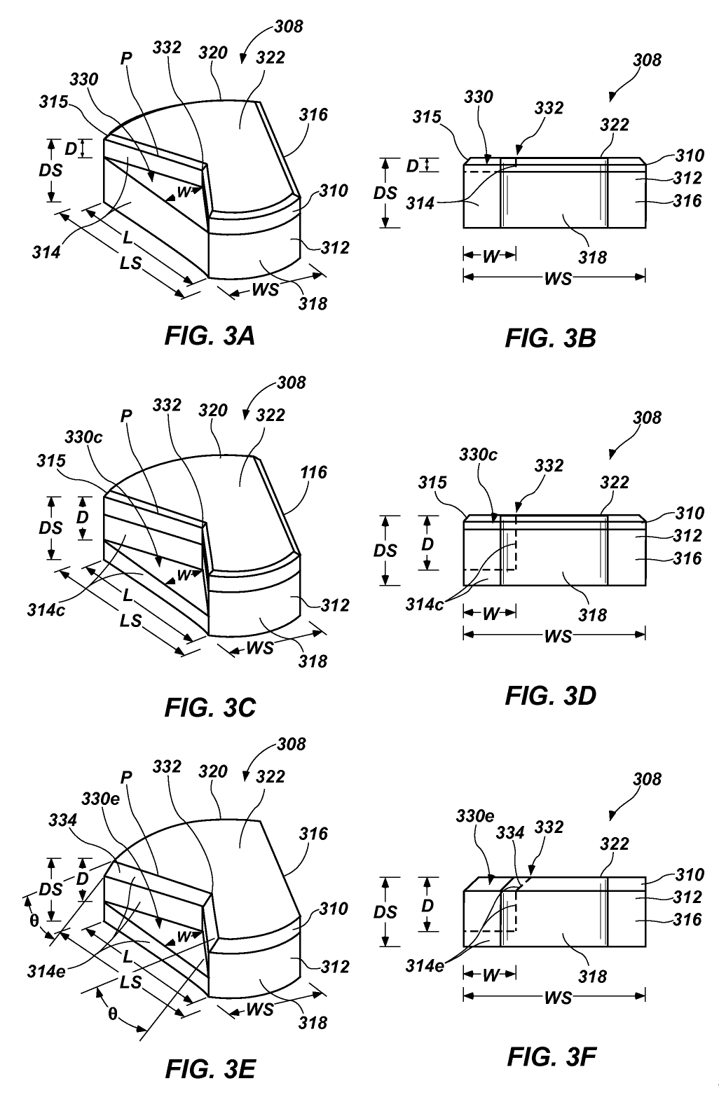

As illustrated in FIG. 1C, at least one of the hollows 130 may have a width W and a depth D. As discussed in more detail below regarding FIGS. 3A-3F, variations of the depth D and/or the width W and/or the length L, or relationships therebetween, of the hollows 130 may provide lubrication, cooling and/or hydrodynamic lift to the superhard bearing elements 108.

Referring now to FIG. 1D, a plurality of superhard bearing elements 108 may be circumferentially distributed about the thrust axis 124 such that the leading side 114 at least partially defines the hollow 130 of each superhard bearing element 108. Put another way, the hollow 130 is defined by the leading side 114, generally converging to a point nearer to the trailing side 116, such that upon rotation R the leading side 114 passes a point relative to the superhard bearing element 108 before the trailing side 116. As shown by flow direction arrows in FIG. 1D, when the support ring 102 rotates in direction R, the hollows 130 may collect and pump and/or impel lubricating fluid flowing out from the center opening 104 of the support ring 102 toward the apex 132 and onto the bearing surfaces 122. In addition, the hollows 130 may cause at least one of cooling of the superhard bearing elements 108, lubrication of the superhard bearing elements 108, and/or enhancing hydrodynamic film formation on the superhard bearing elements 108.

Referring now to FIG. 1E, the superhard bearing elements 108 may be disposed in recesses 106 formed in the support ring 102. In other embodiments the superhard bearing elements 108 may be mounted on top of the support ring 102. In an embodiment, the depth D of the hollow 130 may extend into a recess 106, in other embodiments the depth D of the hollow 130 may only extend to the surface of the support ring 102.

Referring now to FIG. 1F, a plurality of superhard bearing elements 108 may be affixed to a support ring 102 without respect to rotational direction of the support ring 102, as desired. For example, the orientation of the superhard bearing elements 108 may be based on a clockwise or counterclockwise orientation without regard to rotational direction of the support ring 102. In an embodiment, a plurality of superhard bearing elements 108 may be affixed to a support ring 102, each with the leading side 114 following (i.e., adjacent to) the trailing side 116 of another superhard bearing element 108. For example as depicted in FIG. 1F, a plurality of superhard bearing elements 108 may be oriented in the same general direction (i.e., clockwise or counterclockwise orientation). In an embodiment (not shown), at least a first portion of the superhard bearing elements 108 on the support ring 102 may face one general direction (i.e., clockwise or counterclockwise) and a second portion of the superhard bearing elements may face a generally opposite direction as the first portion of the superhard bearing element 108, thus the thrust-bearing assembly formed therewith may operate to cool, lubricate and/or provide hydrodynamic lift if the support ring rotates in either direction. Notwithstanding that FIG. 1F illustrates a thrust bearing, superhard bearing elements substantially as described herein may also be affixed to a radial bearing apparatus in any of the orientations describe herein without respect to the rotational direction of the support ring, as desired.

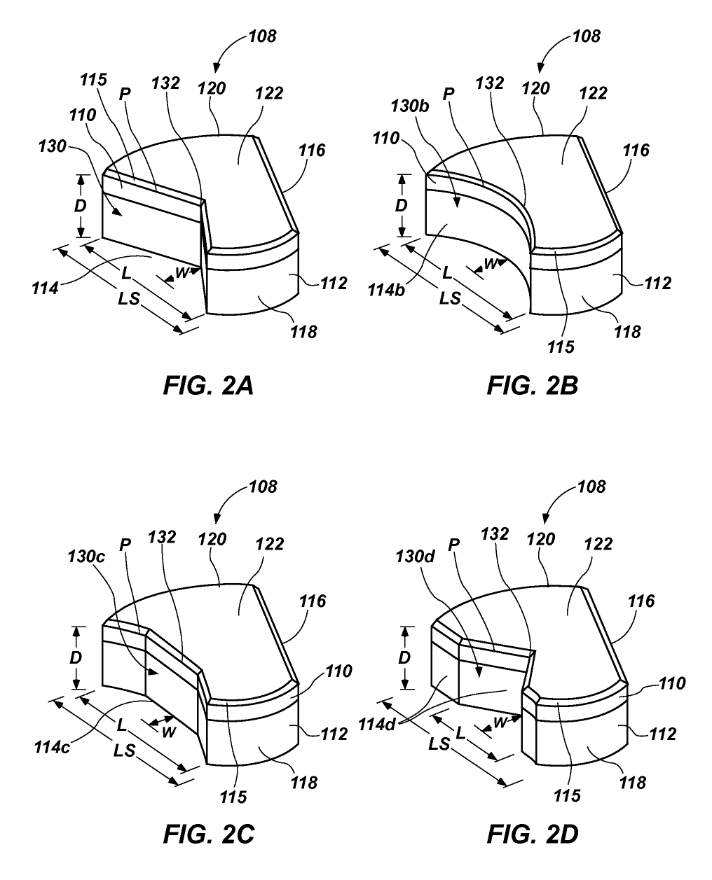

FIGS. 2A-2D are isometric views of superhard bearing elements 108 according to various embodiments. Most features of the illustrated embodiments of the superhard bearing elements 108 depicted in FIGS. 2A-2D are labeled with reference numbers as described in FIGS. 1B-1C. Particularly, the superhard bearing element 108 may include the superhard table 110 bonded to the substrate 112 including the leading side 114, the trailing side 116, the first end 118, the second end 120, and the bearing surface 122 of the superhard table 110 extending between the first end 118 and the second end 120. The superhard bearing element 108 may include a peripherally extending edge chamfer 115, extending around at least a portion of the bearing surface 122, and may be formed between the bearing surface 122 and at least one of the leading side 114, the trailing side 116, the first end 118, the second end 120. In the illustrated embodiment, the superhard bearing element 108 may have a wedge-like shape. In other embodiments, however, the superhard bearing element 108 may have a partial generally rectangular shape, a partial generally rounded rectangular shape, a partial generally oval shape, a partial generally circular shape, a partial generally triangular shape, or the like, or combinations thereof.

The superhard bearing element 108 may include the hollow 130 at least partially defined by the width W, the length L, and the depth D. The leading side 114 at least partially defines the hollow 130. Put another way, when viewed from above, the hollow 130 may be formed by a path P along the leading side 114 of the bearing surface 122 extending to a depth D from the bearing surface 122, thereby at least partially defining the leading side 114, 114b, 114c, 114d and/or the bearing surface 122. In embodiments including a chamfer 115 formed at least between the leading side 114 and the upper surface 122, the chamfer 115 may follow the path P. The hollow 130 may form generally a V-shape (as viewed from above) substantially as depicted by hollows 130 and 130d in FIGS. 2A and 2D respectively. The hollow 130 may define other shapes including but not limited to an arcuate shape substantially as depicted by hollow 130b in FIG. 2B or a smaller V-shape (e.g., an open-ended trapezoidal shape) substantially as depicted by hollow 130c in FIG. 2C, or other multi-angular shapes such as open ended squares, rectangles or pentagons. It will be further understood that variations of length L, width W, and depth D of the shapes the hollow 130 are contemplated, including but not limited to wider shapes, longer shapes, shapes having shallow depths, shapes having a wider or longer V-shape, shapes having a wider or longer arc, shapes forming a longer or wider truncated V-shape. The shape of the hollow 130 may be configured to pump lubricating fluid onto the bearing surface 122 by forcing (e.g. pumping or impelling) the lubricating fluid toward the apex 132 of the hollow 130, thereby providing the fluid more upward force away from the support ring 102 and toward the bearing surface 122. In addition, the shape of the hollow 130 may cool the superhard bearing element 108 by increasing the fluid flow between the bearing surface 122 and/or the superhard bearing element 108 in contact with the lubricating fluid and/or creating turbulent flow within the lubricating fluid.

In an embodiment, the hollow 130 may be formed between the first end 118 and the second end 120 and at least partially define the leading side 114. The hollow 130 may have a length L and may be disposed between the first end 118 and the second end 120 which define a total length LS of the superhard bearing element 108. In an embodiment, the length L of the hollow 130 may extend along the entire portion of the length LS of the superhard bearing element 108 between the first end 118 and the second end 120. In other embodiments, the length L of the hollow 130 may extend only a portion of the length LS of the superhard bearing element 108. For example, the hollow 130 may extend between the first end 118 and an intermediate point between the first end 118 and the second end 120. In another embodiment, and as depicted in the embodiment in FIG. 2D, the hollow 130d may extend between a point intermediate the first end 118 and the second end 120 and another point intermediate the first end 118 and the second end 120. In another embodiment, the hollow 130d may extend from an intermediate point between the first end 118 and the second end 120 and the second end 120.

FIGS. 3A, 3C, and 3E are isometric views of superhard bearing elements 108 according to various embodiments. The superhard bearing element 308 may include a superhard table 310 bonded to a substrate 312 including a leading side 314, a trailing side 316, a first end 318, a second end 320, and a bearing surface 322 of the superhard table 310 extending between the first end 318 and the second end 320. In an embodiment, the superhard table 310 may comprise a PCD table. The superhard bearing element 308 may be made from any of the materials discussed above for the superhard bearing elements 108. In an embodiment, the superhard bearing element 308 may have a wedge-like shape. In other embodiments, however, the superhard bearing element 308 may have a partial generally rectangular shape, a partial generally rounded rectangular shape, a partial generally oval shape, a partial circular shape, a partial generally triangular shape, or the like. In an embodiment, a hollow 330 may be formed in the superhard bearing element 308 such that the depth D of the hollow 330 is the entire depth DS of the superhard bearing element 308. In other embodiments the depth D of the hollow 330 may be less than the entire depth DS of the superhard bearing element 308.

The depth D of the hollows 330, 330c and/or 330e may extend between the bottom portion of the superhard bearing elements 308 and the bearing surface 322. For example, the depth D may be about 0.1 inches to about 0.4 inches, such as about 0.15 inches to about 0.25 inches. The hollows 330 of more than one superhard bearing element 308 may have at least substantially the same depth D. However, in other embodiments, the hollows 330 of more than one superhard bearing element 308 may have at least substantially different depths D.

The depth D of the hollow 330 may be some portion of the thickness of the superhard table 310. For example, as depicted in FIGS. 3A and 3B, the depth D of the hollow 330 may be one hundred (100) percent of the thickness of the superhard table 310. In other embodiments, the depth D of the hollow 130 may be about ten (10) percent, about (20) percent, about forty (40) percent, about fifty (50) percent, about sixty (60) percent, about eighty (80) percent, about ninety (90) percent, or over one hundred (100) percent of the thickness of the superhard table 310. The depth D of the hollow 330 may at least partially define the leading side 314.

In an embodiment, the depth D of the hollow 330 may include the entire thickness of the superhard table 310 and a portion of the substrate 312. For example, as depicted in FIGS. 3C and 3D, the depth D of the hollow 330c travels from the bearing surface 322 through the superhard table 310 and into the substrate 312 before terminating at an intermediate depth in the substrate 312. For example, as depicted in FIGS. 3C and 3D, the depth D of the hollow 330c may be about fifty (50) percent of the thickness of the superhard table 310. In other embodiments, the depth D of the hollow 330 may be about ten (10) percent, about (20) percent, about forty (40) percent, about sixty (60) percent, about eighty (80) percent, about ninety (90) percent, or one hundred (100) percent of the thickness of the superhard table 310. The depth D can vary depending on the desired effect on one or more of cooling of, lubrication of, or hydrodynamic film formation on the superhard bearing element 308. For example, the superhard bearing element 308 including the hollow 330 having a deeper depth D may collect more lubricant, thereby forcing more lubricant onto the bearing surface 322, than a second one of the superhard bearing elements 308 including the hollow 330 with shallower depth D. In another embodiment, the superhard bearing element 308 including the hollow 330 having a shallower depth D may more efficiently pump or force lubricant to the bearing surface 322 based on factors such as, but not limited to, rotational speed of the bearing assembly, lubricant pressure in the bearing assembly, and distance of the gaps 125 between superhard bearing elements 108 in the bearing assembly, and combinations thereof.

In an embodiment, a superhard bearing element 308 may include a hollow 330 having multiple depths D, thereby defining a step configuration. The multiple depths D may include substantially all of the depth DS of the superhard bearing element 308 and any at least a single intermediate point between the bearing surface 322 and the depth DS.

Referring to FIGS. 3E and 3F, the hollow 330e may include a ramped feature 334 at least partially defining the hollow 330e and the leading side 314e.

FIGS. 3B, 3D, and 3F are front elevation views of the corresponding superhard bearing elements 308 depicted in FIGS. 3A, 3C and 3E respectively. As illustrated in FIGS. 3B and 3D, the leading side 314 and 314c at least partially defining the hollows 130 may form an angle substantially perpendicular to the bearing surface 322. In other embodiments, as discussed more below and as depicted in FIGS. 3E and 3F, the leading side 314e at least partially defining the hollow 330 may include at least one ramped feature 334 sloping relative to the bearing surface at an angle θ.

As illustrated in FIGS. 3A-3F, leading sides 314-314e at least partially defining the hollows 330-330e respectively, and may include a generally rectangular cross-section, a ramped cross section, combinations thereof, or the like. In an embodiment, the leading side 314 at least partially defining the hollows 330 may include smooth and/or irregular surfaces to influence lubrication and/or cooling of the superhard bearing element 308. For example, in an embodiment, the leading side 314 comprising the hollow 330 may include portions having irregular or textured surfaces configured to increase heat dissipation by increasing turbulent flow of the lubricating fluid.

As illustrated in FIGS. 3A-3D, superhard bearing elements 308 may include a peripherally extending edge chamfer 315 extending around at least a portion of the bearing surface 322. The chamfer 315 may be formed between the bearing surface 322 and at least one of the leading side 314, the trailing side 316, the first end 318, or the second end 320. As demonstrated by FIGS. 3A-3F, the chamfer 315 is smaller than the ramped feature 334 and is intended to provide a relief at the intersection of the sides, ends, and bearing surfaces, wherein the much larger ramped feature 334 is intended to direct, pump, or impel lubricating fluid onto the bearing surface 122.

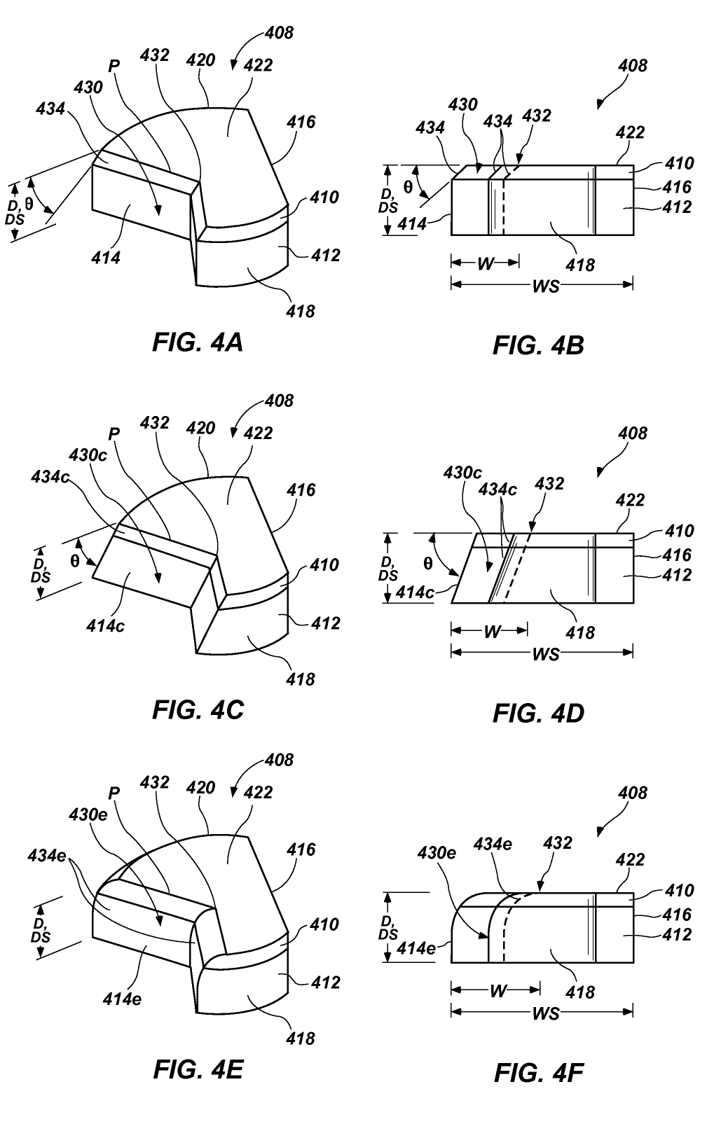

Referring to FIGS. 4A-4F, various embodiments of superhard bearing elements 408 having a leading side 414-414e at least partially defining a hollow 430-430e and ramped features 434-434e are depicted. In an embodiment, the ramped feature 434 or 434c may include a flat surface disposed at a constant angle θ sloping with respect to the bearing surface 422 (e.g., sloping negatively away from the bearing surface 422). In an embodiment substantially as depicted in FIGS. 4E and 4F, the ramped feature 434e may comprise a rounded surface (e.g., a domed surface, a filleted or radiused edge, a convex surface, a concave surface, an ovoid surface, or any other curved surface). In another embodiment, the ramped feature may include a plurality of flat or planar surfaces, each forming a distinct angle θ with respect to the bearing surface. The presence of at least one ramped feature 434 may direct lubricating fluid onto the bearing surface 422 by forcing (e.g. pumping and/or impelling) the lubricating fluid onto the bearing surface 422. The presence of at least one ramped feature 434 defining the hollow 430 may cool, lubricate and/or provide hydrodynamic lift to the superhard bearing element 408 by increasing the fluid flow between the bearing surface 422 and an opposing bearing surface 422 and/or increasing the area of the superhard bearing element 408 in contact with the lubricating fluid and/or creating turbulent flow within the lubricating fluid.

FIGS. 4A, 4C, and 4E are isometric views of superhard bearing elements 408 according to various embodiments. The superhard bearing element 408 may include a superhard table 410 bonded to a substrate 412 including the leading side 414, a trailing side 416, a first end 418, a second end 420, the bearing surface 422 of the superhard table 410 extending between the first end 418 and the second end 420, the hollow 430 at least partially defined by the leading side 414, the bearing surface 422, and the at least one ramped feature 434 sloping with respect to the superhard bearing surface at an angle θ, with the ramped feature 434 at least partially defining the leading side 414. The superhard bearing element 408 may be made from any of the materials discussed above for the superhard bearing elements 108 (i.e., PCD). The superhard bearing element 408 may have a wedge-like shape. In other embodiments, the superhard bearing element 408 may have a partial generally rectangular shape, a partial generally rounded rectangular shape, a partial generally oval shape, a partial generally circular shape, a partial generally triangular shape, or the like. The hollow 430 of the superhard bearing element 408 may form by way of non-limiting example, generally, a V-shape, a U-shape, an open-ended trapezoidal shape, or variations and/or combinations of the foregoing. The ramped feature 434 may generally conform to the shape of the hollow 430. In other embodiments, the ramped feature 434 may augment the shape of the hollow 430, thereby widening the width W and/or lengthening length L the hollow 430.

In an embodiment substantially as depicted in FIGS. 4C and 4D, the ramped feature 434c may include the entire depth D of the hollow 430c. In another embodiment, substantially as depicted in FIGS. 4A and 4B, the ramped feature 434 may extend along only a portion of the depth D of the hollow 430. In another embodiment, the ramped feature 434 may be disposed on the bottom portion of the hollow 430. In another embodiment, the ramped feature 434 may be disposed on the upper most portion of the hollow 430. In another embodiment, the ramped feature 434 may include combinations of the foregoing.

FIGS. 4B, 4D, and 4F are front elevation views of the corresponding superhard bearing elements 408 depicted in FIGS. 4A, 4C and 4E respectively. As illustrated in FIGS. 4B and 4D, the ramped feature 434 and 434c may form an angle θ that slopes with respect to the bearing surface 422, the angle θ being less than 90 degrees. As depicted in FIG. 4F, the ramped feature 434e may form a rounded edge.

FIGS. 4A and 4B depict an embodiment of the superhard bearing element 408 including the hollow 430 and the ramped feature 434 including only a portion of the depth D of the hollow 430. In an embodiment, the ramped feature 434 may be formed only on the superabrasive table 410. In an embodiment, the ramped feature 434 may be disposed at upper portion of the hollow 430 (i.e. near the bearing surface 422) at least partially defined by the leading side 414 of the bearing element 408. In another embodiment, the ramped feature 434 may be disposed over at least a portion of substrate 412 of the bearing element 408. In another embodiment, the ramped feature 434 may include angled surfaces having a greater area nearest the apex 432 than an area of an angled surface near the first end 418 and second end 420. Put another way, the ramped feature 434 may taper from larger area to smaller area as the ramped feature moves outward from the apex 432 and nears the first end 418 and the second end 420. The angle θ of the ramped feature 434 may be at least: about ten degrees (10°); about twenty degrees (20°); about thirty degrees (30°); about forty five degrees (45°); about sixty degrees) (60°; or about seventy five degrees (75°) sloping negatively away from the bearing surface 422 of a superhard bearing element 408. In other embodiments, the angle θ of the ramped feature 434 may be about 10 degrees (10°) to about eighty degrees (80°); about twenty degrees (20°) to about sixty degrees (60°), to about thirty degrees (30°) to about fifty degrees (50°); or at least about forty five degrees (45°) sloping negatively away from the bearing surface 422 of a superhard bearing element 408.

FIGS. 4C and 4D depict an embodiment of a superhard bearing element 408 including the hollow 430c and the ramped feature 434c at least partially defined by the leading side 414c. In an embodiment, the ramped feature 434c may extend along the entire depth D of the hollow 430c. In another embodiment, the ramped feature 434c may extend along the entire depth D of the hollow 430c, which further includes the entire depth DS of the superhard bearing element 408. The angle θ of the ramped feature 434c may be at least: about ten degrees (10°); about twenty degrees (20°); about thirty degrees (30°); about forty five degrees (45°); about sixty degrees (60°); or about seventy five degrees (75°) sloping negatively away from the bearing surface 422 of a superhard bearing element 408. In other embodiments, the angle θ of the ramped feature 434c may be about 10 degrees (10°) to about eighty degrees (80°); about twenty degrees (20°) to about sixty degrees (60°), to about thirty degrees (30°) to about fifty degrees) (50°; or at least about forty five degrees (45°) sloping negatively away from the bearing surface 422 of the superhard bearing element 408.

FIGS. 4E and 4F depict an embodiment of the superhard bearing element 408 including the hollow 430e at least partially defined by the leading side 414e and the ramped feature 434e at least partially defined by the leading side 414e. In an embodiment, the ramped feature 434e may include a rounded edge forming a convex surface. In another embodiment, the rounded edge may form a concave surface.

In an embodiment, the ramped feature 434e may comprise a compound curved feature. For example, the ramped feature 434e may comprise both a planar (e.g., ramped) feature sloping at a constant angle and a rounded edge. For example, the hollow 430e may have the shape of an open-ended trapezoid and the ramped feature 434e may include a more sharply decreasing angle θ nearer the first end 418 and the second end 420 than at a point central to the bearing surface 422, thereby forming a substantially conical-funnel or frustoconical indentation (i.e. shape of a truncated cone) in the superhard bearing element 408 converging towards and terminating at the bearing surface 422. Different compound shapes and/or surfaces may be formed in the bearing element 408.

Configuration of at least one of position, length, shape, or angle θ of the at least one ramped feature 434 may provide at least one of cooling, lubrication, or hydrodynamic lift by forcing (e.g. pumping) the lubricating fluid onto the bearing surface 422. Such a configuration may increase the fluid flow between the bearing surface 422 and an opposing bearing surface and/or increase the amount of area of the superhard bearing element 408 in contact with the lubricating fluid and/or creating turbulent flow within the lubricating fluid. For example, a superhard bearing element 408 including the ramped feature 434 having a smaller (i.e., shallower) or larger (i.e., deeper) angle θ may collect and impel more lubricant toward an apex 432 of the hollow 430, thereby forcing more lubricant toward the bearing surface 422, than a second superhard bearing element 408 not having the ramped feature 434. In another example, a superhard bearing element 408 including the ramped feature 434 having a smaller (i.e., shallower) or larger (i.e., deeper) angle θ may more efficiently pump, impel, or force lubricant to the bearing surface 422 based on additional factors such as, but not limited to, rotational speed of the bearing assembly, lubricant pressure in the bearing assembly, and distance of the gaps 125 in the bearing assembly, and combinations thereof.

In an embodiment, a superhard bearing element may include a leading side defining more than one hollow. For example, a plurality of hollows may be formed by the leading side of a superhard bearing element, the plurality of hollows sequentially spaced along the leading side extending from the first end to the second end. The size, shape, location, and/or spacing of the plurality of hollows formed by the leading side of a superhard bearing element in such an embodiment may vary according to the number and size of the adjacent hollows. The size, shape, location, orientation and/or spacing of such plurality of hollows resemble any of the embodiments described herein. Further, a plurality of hollows may also comprise more than one hollow that touches or overlaps another hollow.

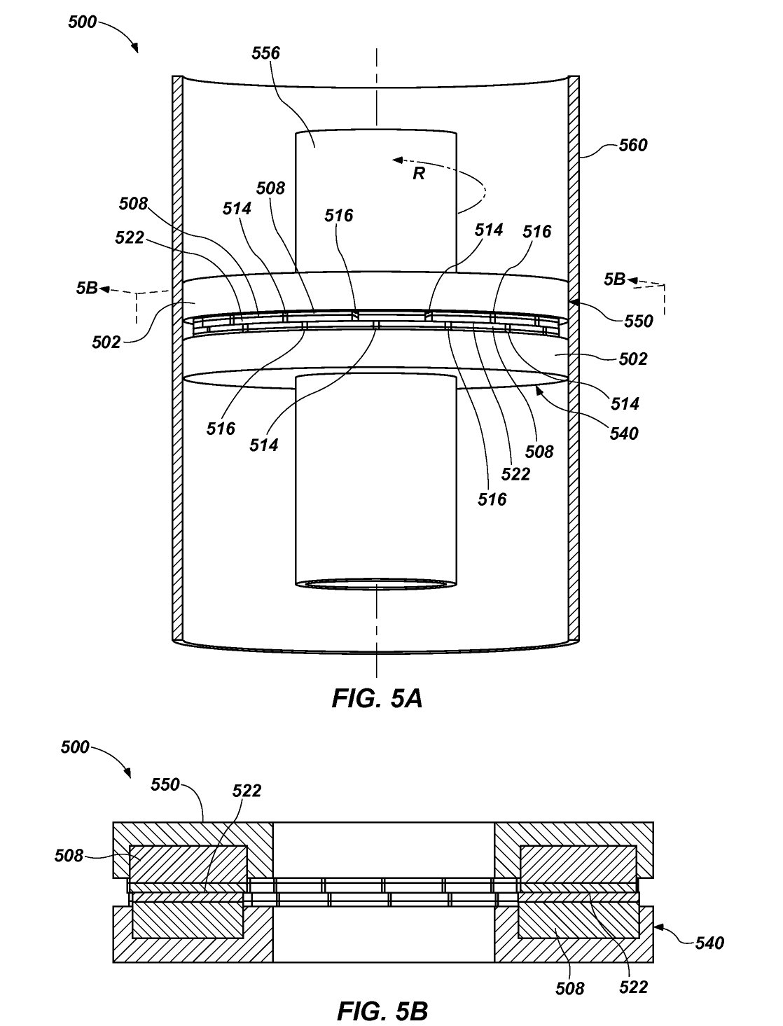

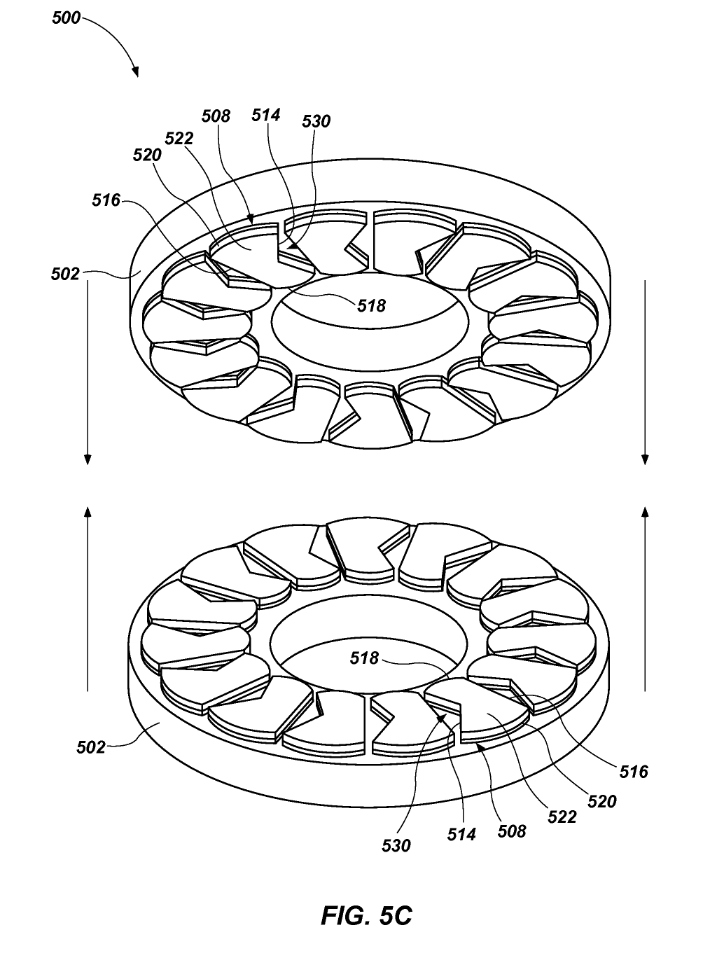

Any of the above-described thrust-bearing assembly embodiments may be employed in a thrust-bearing apparatus. FIG. 5A is an isometric view of a thrust-bearing apparatus 500. The thrust-bearing apparatus 500 may include a stator 540 configured as any of the previously described embodiments of thrust-bearing assemblies 100. The stator 540 may include a plurality of circumferentially-adjacent superhard bearing elements 508. The superhard bearing elements 508 may include a bearing surface 522 and at least some of the superhard bearing elements 508 may exhibit, for example, the configuration of any of the superhard bearing elements 108, 308, and 408 having a hollow therein substantially as depicted and described regarding any of FIGS. 1B-C, 2A-D, 3A-F, 4A-F, or combinations thereof. The superhard bearing elements 508 may be mounted or otherwise attached to a support ring 502. The thrust-bearing apparatus 500 further may include a rotor 550. The rotor 550 may include a support ring 502 and a plurality of superhard bearing elements 508 mounted or otherwise attached to the support ring 502, with each of the superhard bearing elements 508 having a bearing surface 522. As shown, a shaft 556 may be coupled to the support ring 502 and operably coupled to an apparatus capable of rotating the shaft 556 in a direction R (or in a generally opposite direction), such as a downhole motor. For example, the shaft 556 may extend through and may be secured to the support ring 502 of the rotor 550 by press-fitting or threadly coupling the shaft 556 to the support ring 552 or another suitable technique. A housing 560 may be secured to the support ring 502 of the stator 540 and may extend circumferentially about the shaft 556 and the rotor 550. The rotational direction R of the shaft defines the direction of relative rotation for the superhard bearing elements 508 disposed on the stator 540 and the rotor 550. For example, the rotational direction R provides that the superhard bearing elements 508 disposed on the rotor 550 and stator 540 each have a leading side 514 and a trailing side 516, respectively.

The operation of the thrust-bearing apparatus 500 is discussed in more detail with reference to FIG. 5B in which the shaft 556 and housing 560 are not shown for clarity. In operation, one or more of lubricating fluid, cooling fluid, drilling fluid, or mud may be pumped between the shaft 556 and the housing 560, and between the superhard bearing elements 508 of the rotor 550. Hollows (not shown) of the superhard bearing elements 508 of the rotor 550 may pump lubricating fluid between the bearing surfaces 522 of the stator 540 and the bearing surfaces 522 of the rotor 550 which in turn can greatly reduce friction between the bearing surfaces 522 of the stator 540 and the bearing surfaces 522 of the rotor 550. The hollows (not shown) may also cool the superhard bearing elements 508 of the rotor 550 by increasing the surface area of the superhard bearing elements 508 and/or the bearing surfaces 522 in contact with the lubricating fluid. Moreover, under certain operational conditions the thrust-bearing apparatus 500 may be operated as a hydrodynamic bearing. For example, where the rotational speed of the rotor 550 is sufficiently great and the thrust load is sufficiently low, a fluid film may develop between the bearing surfaces 522 of the stator 540 and the bearing surfaces 522 of the rotor 550. The fluid film may have sufficient pressure to reduce or prevent contact between the respective bearing surfaces 522 of the stator 540 and the rotor 550 and thus, substantially reduce wear of the superhard bearing elements 508. In such a situation, the thrust-bearing apparatus 500 may be described as operating hydrodynamically. Thus, the thrust-bearing apparatus 500 may be operated to provide lubrication to the contact area between the bearing surfaces 522 of the stator 540 and the bearing surfaces 522 of the rotor 550 and/or as a hydrodynamic bearing.

For example, the thrust-bearing apparatus 500 may include superhard bearing elements 508 disposed on a stator 540, at least some of the superhard bearing elements 508 including a hollow (not shown), substantially as described above regarding any superhard bearing element 108, 308 and 408 as depicted and described regarding FIGS. 1B-C, 2A-D, 3A-F, and 4A-F. The hollow (not shown) configured to collect and converge the lubricant or fluid present in the assembly toward an apex (not shown) of a hollow (not shown) to pump the fluid onto the bearing surface 522. The hollow (not shown) may be disposed on the leading side 514 (shown in FIG. 5A) the superhard bearing element 508 according to the relative rotation of the superhard bearing element 508. Additionally, the exemplary thrust-bearing apparatus may include a set of superhard bearing elements 508 disposed on a rotor 550, such that when the superhard bearing elements 508 disposed on the rotor 550 pass the superhard bearing elements 508 disposed on the stator 540 the lubricant or fluid in the gaps 125 between the opposing superhard bearing elements 508 is forced (i.e. pumped) between the bearing surfaces 522 on the rotor 550 and the stator 540 thereby providing lubrication, cooling, and hydrodynamic lift in some conditions between the superhard bearing elements disposed on the rotor 550 and the stator 540. In an embodiment, the hollows (not shown) on the superhard bearing elements 508 disposed on the stator 540 may additionally or alternatively be included on superhard bearing elements 508 disposed on the rotor 550. Embodiments or variations of the embodiments of a hollow (not shown) on the superhard bearing elements 508, substantially as described above regarding superhard bearing element 108, 308 and 408 as depicted and described regarding FIGS. 1B-C, 2A-D, 3A-F, and 4A-F may be utilized to increase or decrease the fluid or lubricant forced (i.e. pumped) onto the surfaces 522 of the opposing superhard bearing elements 508.

Referring now to FIG. 5C, a thrust-bearing apparatus may comprise two opposing support rings 502 in which one of the support rings 502 may be configured as a stator and the other one of the support rings 502 may be configured as a rotor. In an embodiment, one or both of the opposing support rings 502 may include a plurality of superhard bearing elements 508, at least some of which may include a hollow 530 defined by a leading side 514 of the superhard bearing element 508. For example, as depicted in FIG. 5C, both support rings 502 may include a plurality of superhard bearing elements 508, including a bearing surface 522, a first end 518, a second end 520, a trailing side 516, a leading side 514, and a hollow 530 at least partially defined by the leading side 514. In such an embodiment, when one support ring 502 is configured as a rotor, and the other support ring 502 is configured as a stator, the opposing bearing surfaces 522 on the superhard bearing elements 508 on the opposing support rings 502 may rotate relative to each other in rotationally opposite directions. The relative orientation of the superhard bearing elements 508 disposed on the opposing support rings 502 may be such that the leading sides 514 defining the hollows 530 of the opposing superhard bearing elements 508 may encounter one another before the trailing sides 516 encounter one another. In another embodiment, the leading side 514 defining the hollow 530 may encounter a leading side that is substantially planar (i.e., a superhard bearing element 508 having no hollow 530 therein or a superhard bearing element 508 oriented such that the trailing side 516 leads the relative rotation of the superhard bearing element against the opposing superhard bearing element 508). Either one of the thrust-bearing assemblies depicted in FIG. 5C may be configured as a rotor, or as a stator.

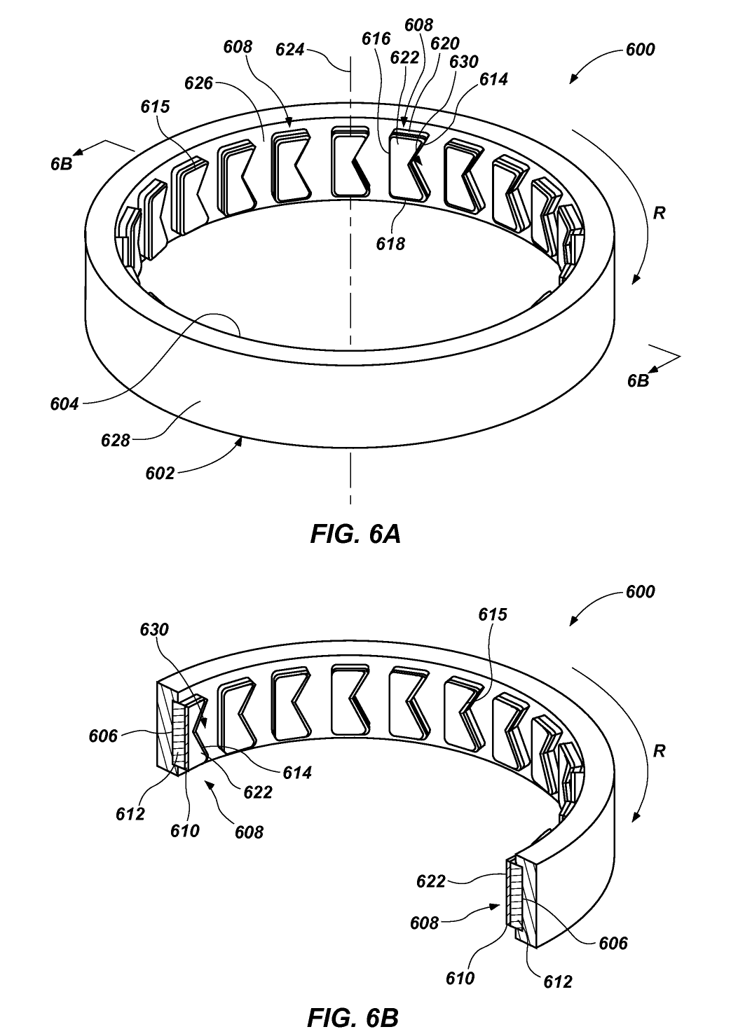

The concepts used in the thrust-bearing assemblies and apparatuses described above may also be employed in the radial bearing assemblies and apparatuses. FIGS. 6A and 6B are isometric and isometric cutaway views, respectively, illustrating a radial bearing assembly 600 according to an embodiment. The radial bearing assembly 600 may include a support ring 602 extending about a rotation axis 624. The support ring 602 may include an inner peripheral surface 626 defining a central opening 604 that is capable of receiving, for example, an inner support ring or inner race. The support ring 602 may also include an outer peripheral surface 628. A plurality of superhard bearing elements 608 may be distributed circumferentially about the rotation axis 624. Each superhard bearing element 608 may include a superhard table 610 including a concavely-curved bearing surface 622 (e.g., curved to lie on hypothetical, generically cylindrical surface). Each superhard table 610 may be bonded or attached to a corresponding substrate 612 (shown in FIG. 6B). The superhard bearing elements 608 may have a generally rounded rectangular shape and each may be made from any of the materials discussed above for the superhard bearing elements 108. In other embodiments, the superhard bearing elements 608 may have a non-cylindrical shape, generally wedge-like shape, a partial generally oval-like shape, a cylindrical shape, a partial circular shape or any other suitable shape. Similar to the superhard bearing elements 108, the superhard bearing elements 608 may include a leading side 614 relative to the direction of rotation R, a trailing side 616, a first end 618, a second end 620, with the bearing surface 622 extending between the first end 618 and the second end 620. In an embodiment, at least some of the superhard bearing elements 608 may include a hollow 630 formed on the leading side 614 along a path P and at least partially defined the leading side 614. The hollow 630 may be configured similar to the hollow 130-130d, 330-330e, 430-430e, or combinations thereof, substantially as depicted and described regarding FIGS. 1B-C, 2A-D, 3A-F, and 4A-F or any other hollow disclosed herein. In embodiments, superhard bearing elements 608 may include a peripherally extending edge chamfer 615 formed on at least a portion of the bearing surface 622. For example, the chamfer 615 may be formed at the intersection of the bearing surface 622 and at least one of the leading side 614, the trailing side 616, the first end 618, or the second end 620. The chamfer 615 may be configured substantially as any of those described herein according to reference numbers 115 and 315. As illustrated in FIGS. 6A and 6B, the superhard bearing elements 608 may be distributed circumferentially about the rotation axis 624 in corresponding recesses 606 formed in the support ring 602 and arranged in a single row. In other embodiments, the superhard bearing elements 608 may be circumferentially distributed in two rows, three rows, four rows, or any number of rows.

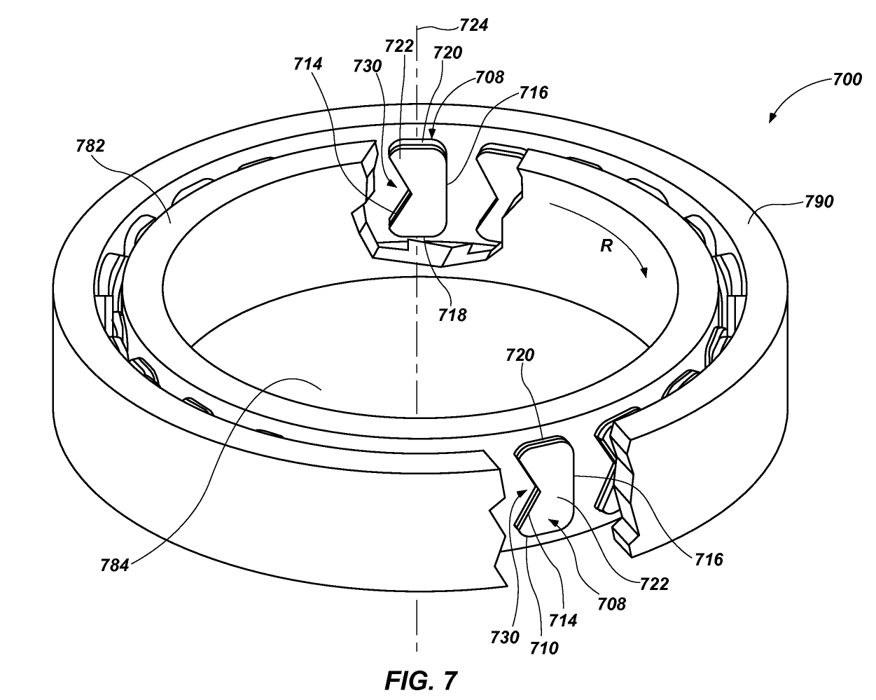

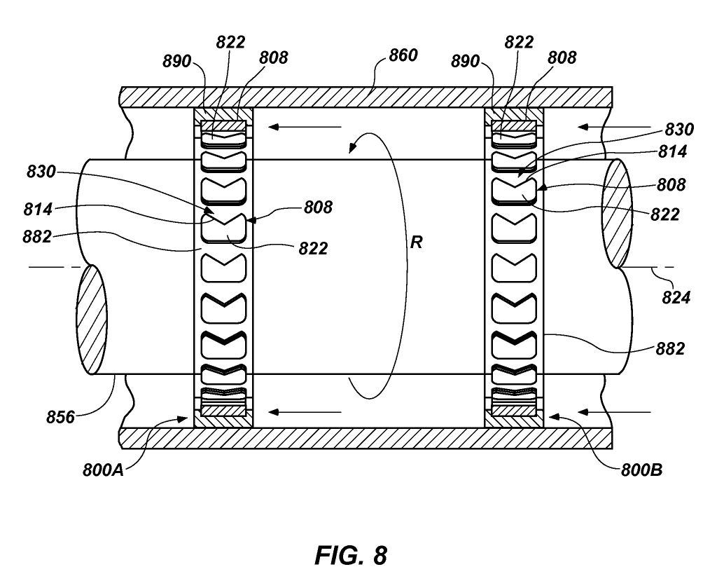

FIG. 7 is an isometric cutaway view of a radial bearing apparatus 700 according to an embodiment. The radial bearing apparatus 700 may include an inner race 782 (i.e., a rotor). The inner race 782 may define an opening 784 and may include a plurality of circumferentially-adjacent superhard bearing elements 708 distributed about a rotation axis 724, each of which includes a convexly-curved bearing surface 722. The radial bearing apparatus 700 may further include an outer race 790 (i.e., a stator) that extends about and receives the inner race 782. The outer race 790 may include a plurality of circumferentially-adjacent superhard bearing elements 708 distributed about the rotation axis 724, each of which includes a concavely-curved bearing surface 722 curved to correspond to the convexly-curved bearing surfaces 722. The superhard bearing elements 708 may have a generally rounded rectangular shape and each may be made from any of the materials discussed above for the superhard bearing elements 108. In other embodiments, the superhard bearing elements 708 and 786 may have a generally wedge-like shape, a generally oval shape, a generally cylindrical shape, or any other suitable shape. The terms “rotor” and “stator” refer to rotating and stationary components of the radial bearing apparatus 700, respectively. Thus, if the outer race 790 is configured to remain stationary, the outer race 790 may be referred to as the stator and the inner race 782 may be referred to as the rotor.

At least some of the superhard bearing elements 708 may include a hollow 7730 formed by at least a portion of the leading side 714 along a path P and at least partially defined by the leading side 714. The hollow 730 may be configured to pump lubricating fluid onto the bearing surfaces 722 of the superhard bearing elements 708 disposed on inner race 782 and/or the outer race 790 (i.e., the rotor and/or the stator). Moreover, under certain operating conditions the hollow or hollows 730 may help form a fluid film similar to the hollows of the superhard bearing elements described regarding FIGS. 5A and 5B, thereby providing hydrodynamic lift. A shaft or spindle (not shown) may extend through the opening 784 and may be secured to the rotor 782 by press-fitting the shaft or spindle to the rotor 782, threadly coupling the shaft or spindle to the rotor 782, or another suitable technique. A housing (not shown) may also be secured to the stator 790 using similar techniques.

In an embodiment, a radial bearing apparatus such as the depicted in FIG. 7 may comprise two opposing support rings configured as an inner race 782 and an outer race 790, wherein one support ring may be configured as a stator and the other support ring may be configured as a rotor. In an embodiment, one or both of the inner race 782 and an outer race 790 may include a plurality of superhard bearing elements 708, at least some of which may include a hollow 730 defined by a leading side 714 of the superhard bearing element 708. For example, as depicted in FIG. 5C, both inner race 782 and an outer race 790 may include a plurality of superhard bearing elements 708, including a bearing surface 722, first end 718, a second end 720, a trailing side 716, a leading side 714, and a hollow 730 at least partially defined by the leading side 714. In an embodiment, the bearing surfaces 722 on the superhard bearing elements 708 on the inner race 782 may include a convex curvature generally parallel to the surface of the inner race 782 and the bearing surface 722 superhard bearing elements 708 on the outer race 790 may include concave curvature generally parallel to the curvature of the surface of the outer race 790. In such an embodiment, when one support ring (i.e., inner or outer race) is configured as a rotor, and the other support ring is configured as a stator, the opposing bearing surfaces 722 on the superhard bearing elements 708 on the opposing support rings may rotate against each other in rotationally opposite directions. The relative orientation of the superhard bearing elements 708 disposed on the opposing support rings may be such that the leading sides 714 defining hollows 730 of the opposing superhard bearing elements 708 may encounter one another before the trailing sides 716 encounter one another. In another embodiment, a leading side 714 defining a hollow 730 may encounter a leading side that is substantially planar (i.e., a superhard bearing element 708 having no hollow 730 therein or a superhard bearing element 708 oriented such that the trailing side 716 leads the relative rotation of the superhard bearing element against the opposing superhard bearing element 708). Either one of the radial bearing assemblies depicted in FIG. 7 may be configured as a rotor, or as a stator.

The radial bearing apparatus 700 may be employed in a variety of mechanical applications. For example, so-called “rotary cone” rotary drill bits, pumps, transmissions or turbines may benefit from a radial bearing apparatus discussed herein.

It is noted that the outer race 790 (i.e. stator) of the radial bearing apparatus 700 is shown including a plurality of circumferentially-distributed superhard bearing elements 708 including hollow 730 formed by the leading side 714 of relative rotation of the superhard bearing element 708. At least one of the superhard bearing elements 708 may include the hollow 730, as previously described regarding FIGS. 5A and 5B, configured to lubricate, cool and/or provide hydrodynamic lift to the superhard bearing elements 708 of the outer race during operation. However, in other embodiments, an outer race 790 of a radial bearing apparatus 700 may include a plurality of circumferentially-distributed superhard bearing elements 708 without a hollow 730 formed therein. In another embodiment, a radial bearing apparatus 700 may include the outer race 790 having at least one superhard bearing element 708 including the hollow 730, and an inner race 782 of the radial bearing apparatus 700 may include a plurality of circumferentially-distributed superhard bearing elements 708 without the hollow 730 formed therein.

FIG. 8 is an isometric cutaway view of two radial bearing apparatuses 800A, 800B according to another embodiment. The radial bearing apparatuses 800A, 800B may include an inner race 882 (i.e., rotor). The inner race 882 may include a row of circumferentially-distributed superhard bearing elements 858, each of which includes a convexly-curved bearing surface 888. In other embodiments, the inner race 882 may include two rows, three rows, or any number of rows of the superhard bearing elements 858.

The radial bearing apparatuses 800A, 800B may further include an outer race 890 (i.e., a stator) that extends about and receives the inner race 882. The outer race 890 may include one row of circumferentially-distributed superhard bearing elements 808, each of which includes a concavely-curved bearing surface 822 curved to correspond to the convexly-curved bearing surfaces 888. In other embodiments, the outer race 890 may include two rows, three rows, or any number of rows of the superhard bearing elements 808.

The superhard bearing elements 808 and 858 may have a generally rectangular shape and each may be made from any of the materials discussed above for the superhard bearing elements 108. The terms “rotor” and “stator” refer to rotating and stationary components of the radial bearing apparatuses 800A, 800B, respectively. Thus, if the outer race 890 is configured to remain stationary, the outer race 890 may be referred to as the stator and the inner race 882 may be referred to as the rotor.

At least some of the superhard bearing elements 808 may include a hollow 880 formed on the leading side 814 of the bearing element 808. The hollows 830 may be oriented in a rotational direction R of the inner race 882 about a rotation axis 824 (i.e., the hollow 830 faces toward the rotational direction R) to pump lubricating fluid onto the bearing surfaces 822. A shaft or spindle 856 may extend through each inner race 882 and may be secured to each inner race 882 by press fitting the shaft or spindle 856 to the inner races 882, threadly coupling the shaft or spindle 856 to the inner races 882, or another suitable technique. A housing 860 may also be secured to the outer race 890 using similar techniques. The radial bearing apparatuses 800A, 800B may be employed in a variety of mechanical applications. For example, drill motors and pumps may benefit from the radial bearing apparatuses 800A, 800B.

In operation, rotation of the shaft 856 may cause rotation of the inner race 882 relative to the outer race 890. Lubricating fluid may be pumped between the bearing surfaces 822 of the inner race 882 as shown by the flow arrows. Similar to the description with respect to the thrust bearing apparatus 500, the hollows 830 of the superhard bearing elements 808 may pump lubricating fluid between the bearing surfaces 822 of the superhard bearing elements 808 on the inner race 882 and the outer race 890, thereby cooling, lubricating and/or providing hydrodynamic lift to the superhard bearing elements 808. Accordingly, wear on the superhard bearing elements 808 may be reduced.

It is noted that in other embodiments, the rotor or stator may be configured as any of the previously described embodiments of thrust-bearing assemblies. Moreover, the disclosed thrust-bearing apparatuses may be used in a number of applications such as downhole motors in subterranean drilling systems, directional drilling systems, pumps, transmissions, gear boxes, and many other applications.

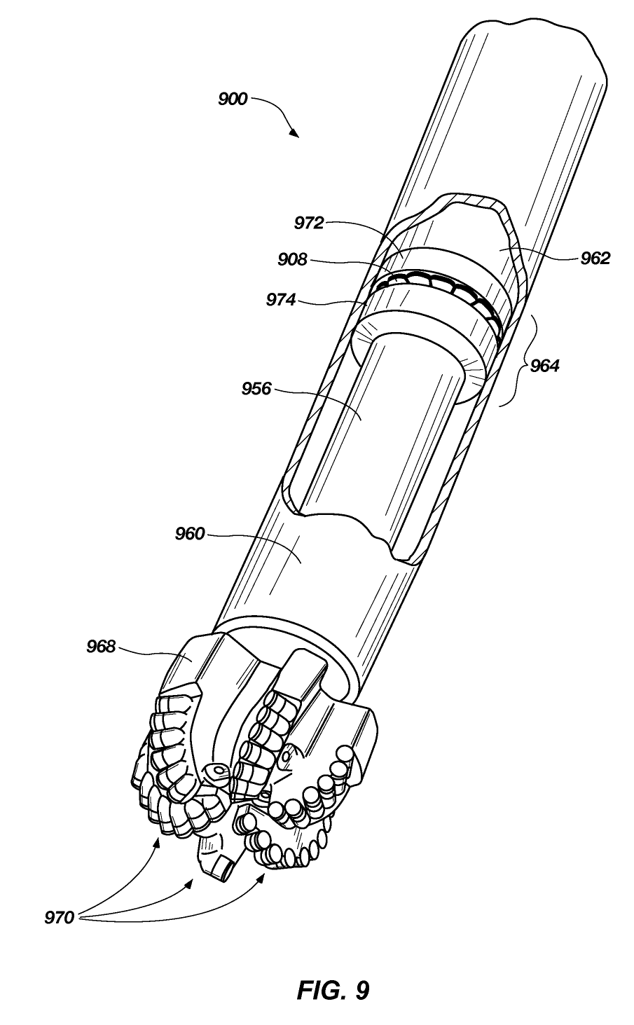

Any of the embodiments for bearing apparatuses discussed above may be used in a subterranean drilling system. FIG. 9 is a schematic isometric cutaway view of a subterranean drilling system 900 according to an embodiment. The subterranean drilling system 900 may include a housing 960 enclosing a downhole drilling motor 962 (i.e., a motor, turbine, or any other device capable of rotating an output shaft) that may be operably connected to an output shaft 856. A thrust-bearing apparatus 964 may be operably coupled to the downhole drilling motor 862. The thrust-bearing apparatus 964 may be configured as any of the previously described thrust-bearing apparatus embodiments. A rotary drill bit 968 may be configured to engage a subterranean formation and drill a borehole and may be connected to the output shaft 956. The rotary drill bit 968 is shown as a fixed cutter rotary bit including a plurality of superabrasive cutting elements 970. However, other embodiments may utilize different types of rotary drill bits, such as core bits, roller-cone bits, eccentric bits, bicenter bits, reamers, reamer wings, or any other downhole tool including superabrasive cutting elements, such as PDCs. As the borehole is drilled, pipe sections may be connected to the subterranean drilling system 900 to form a drill string capable of progressively drilling the borehole to a greater size or depth within the earth. U.S. Pat. Nos. 4,410,054; 4,560,014; 5,364,192; 5,368,398; and 5,480,233, the disclosure of each of which is incorporated herein, in its entirety, by this reference, disclose subterranean drilling systems within which bearing apparatuses utilizing the PCD elements and/or PDCs disclosed herein may be incorporated.

The thrust-bearing apparatus 964 may include a stator 972 that does not rotate and a rotor 974 that may be attached to the output shaft 956 and rotates with the output shaft 956. As discussed above, the thrust-bearing apparatus 964 may be configured as any of the embodiments disclosed herein. For example, the stator 972 may include a plurality of circumferentially-distributed superhard bearing elements 908 similar to the superhard bearing elements 508 shown and described in the thrust-bearing apparatus 500 of FIG. 5A. The stator 972 and/or rotor 974 may include a plurality of circumferentially-distributed superhard bearing elements 108, 308, and/or 408 (not shown) as depicted and described in FIGS. 1A-4F.

In operation, drilling fluid may be circulated through the downhole drilling motor 962 to generate torque and effect rotation of the output shaft 956 and the rotary drill bit 968 attached thereto so that a borehole may be drilled. A portion of the drilling fluid may also be used to lubricate opposing bearing surfaces of the stator 972 and the rotor 974 or providing hydrodynamic lift between the bearing surfaces of the stator 972 and the rotor 974. When the rotor 974 is rotated, hollows of the superhard bearing elements of the stator 972 and/or rotor 974 may pump the drilling fluid onto the bearing surfaces of the stator 972 and/or the rotor 974, as previously discussed.

Although the bearing assemblies and apparatuses described above have been discussed in the context of subterranean drilling systems and applications, in other embodiments, the bearing assemblies and apparatuses disclosed herein are not limited to such use and may be used for many different applications, if desired, without limitation. Thus, such bearing assemblies and apparatuses are not limited for use with subterranean drilling systems and may be used with various mechanical systems, without limitation.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A bearing assembly, comprising:
a plurality of superhard bearing elements distributed circumferentially about an axis, at least one of the plurality of superhard bearing elements including:
a bearing surface including a superhard material; and
a side at least partially defining a hollow sized and configured to force fluid toward the bearing surface during operation, the side further at least partially defining a non-uniform gap between the side and an adjacent superhard bearing element of the plurality of superhard bearing elements; and
a support ring that carries the plurality of superhard bearing elements therein.

2. The bearing assembly of claim 1 wherein the side defining the hollow forms one of a generally V-shape, an arcuate shape, an open-ended generally square shape, an open-ended generally rectangular shape, or an open-ended generally trapezoidal shape.

3. The bearing assembly of claim 2 wherein the hollow includes at least one ramped feature sloping with respect to the bearing surface, the ramped feature formed between the side and the bearing surface.

4. The bearing assembly of claim 3 wherein the at least one ramped feature extends approximately from the support ring and continues to the bearing surface.

5. The bearing assembly of claim 3 wherein the at least one ramped feature between an intermediate point between the support ring and the bearing surface and continues to the bearing surface.

6. The bearing assembly of claim 3 wherein the at least one ramped feature extends approximately from the support ring and continues to an intermediate point between the support ring and the bearing surface.

7. The bearing assembly of claim 3 wherein the at least one ramped feature begins at a first intermediate point between the support ring and the bearing surface and ends at second intermediate point between the support ring and the bearing surface, the second intermediate point positioned closer to the bearing surface than to the first intermediate point.

8. The bearing assembly of claim 3 wherein the hollow and the at least one ramped feature collectively define a substantially conical shape between the side and the bearing surface.

9. The bearing assembly of claim 1 wherein at least some of the plurality of superhard bearing elements includes a substrate and a polycrystalline diamond table bonded to the substrate, the polycrystalline diamond table having a thickness.

10. The bearing assembly of claim 9 wherein the hollow is at least partially defined by at least one ramped feature sloping with respect to the bearing surface, the ramped feature formed between the side and the bearing surface.

11. The bearing assembly of claim 10 wherein the at least one ramped feature is formed upon at least a portion of the substrate and upon at least a portion of the polycrystalline diamond table.

12. The bearing assembly of claim 11, wherein the at least one ramped feature extends between an intermediate point between the substrate and the polycrystalline diamond table, and the bearing surface.

13. The bearing assembly of claim 9, wherein at least some of the plurality of superhard bearing elements including a chamfer formed on the side of the polycrystalline diamond table.

14. The bearing assembly of claim 10 wherein a general shape of the superhard bearing element includes one of a partial generally rectangular shape, a partial generally wedge shape, a partial generally circular shape, or a partial generally oval shape.

15. The bearing assembly of claim 1 wherein the axis is a thrust axis, and wherein the support ring and the plurality of superhard bearing elements define a thrust-bearing assembly; or wherein the axis is a rotation axis, and wherein the support ring and the plurality of superhard bearing elements define a radial bearing assembly.

16. The bearing assembly of claim 1 wherein the plurality of the superhard bearing elements are brazed, interference-fitted, or fastened to the support ring.

17. A method for manufacturing a bearing assembly, the method comprising:
manufacturing a plurality of superhard bearing elements, at least some of the plurality of superhard bearing elements including:
a bearing surface including a superhard material; and
a side at least partially defining a hollow sized and configured to force fluid toward the bearing surface during operation, the side further at least partially defining a non-uniform gap between the side and an adjacent superhard bearing element of the plurality of superhard bearing elements; and
securing the plurality of superhard bearing elements to the support ring.

18. The method of claim 17 wherein manufacturing a plurality of superhard bearing elements includes fabricating a polycrystalline diamond table using a high-pressure/high-temperature process, and affixing the polycrystalline diamond table to a substrate.

19. The method of claim 18 wherein the manufacturing the plurality of superhard bearing elements includes forming the hollow in the side before the plurality of superhard bearing elements are secured to the support ring.

20. The method of claim 19 wherein forming the hollow includes at least one of laser-cutting, electro-discharge machining, grinding, leaching, or milling.

21. The method of claim 18 wherein securing the plurality of superhard bearing elements to the support ring includes at least one of brazing, interference-fitting, or fastening.

22. A bearing apparatus, comprising:
a first bearing assembly including:
a first plurality of superhard bearing elements distributed circumferentially about an axis, at least some of the first plurality of superhard bearing elements including:
a bearing surface including a superhard material;
a side at least partially defining a hollow sized and configured to force fluid toward the bearing surface during operation, the side further at least partially defining a non-uniform gap between the side and an adjacent superhard bearing element of the plurality of superhard bearing elements; and
a first support ring including the first plurality of superhard bearing elements affixed thereto; and
a second bearing assembly including:
a second plurality of superhard bearing elements generally opposing the first plurality of superhard bearing elements; and
a second support ring including the second plurality of superhard bearing elements affixed thereto.

23. The bearing apparatus of claim 22 wherein at least some of the second plurality of superhard bearing elements include a hollow sized and configured to force fluid toward the bearing surface, the hollow at least partially defined by a side of the at least some of the second plurality of bearing elements.

24. The bearing apparatus of claim 22 wherein the first bearing assembly is configured as a stator and the second bearing assembly is configured as a rotor.

25. The bearing apparatus of claim 23 wherein each of the first plurality of superhard bearing elements and the second plurality of superhard bearing elements includes a polycrystalline diamond table affixed to a substrate.

26. The bearing apparatus of claim 23 wherein the hollow includes a ramped feature sloping with respect to the bearing surface.

27. The bearing apparatus of claim 26 wherein the hollow includes a ramped feature sloping with respect to the bearing surface.

28. The bearing apparatus of claim 22, wherein the axis is a thrust axis, and wherein the first and second bearing assemblies define first and second thrust-bearing assemblies; or wherein the axis is a rotation axis, and wherein the first and second bearing assemblies define first and second radial bearing assemblies.

29. The bearing assembly of claim 1 wherein the side defines a leading side.

30. The bearing apparatus of claim 22 wherein the side defines a leading side.
